(19) United States
(12) Patent Application Publication
(10) Pub. No.: US 2012/0100518 A1
(43) Pub. Date: Apr. 26, 2012

(54) TOUCH-SCREEN BASED INTERACTIVE GAMES FOR INFANTS AND TODDLERS

(75) Inventor: Dan Dan Yang, Ottawa (CA)

(73) Assignee: RULLINGNET CORPORATION LIMITED, Hong Kong (HK)

(21) Appl. No.: 12/908,390

(22) Filed: Oct. 20, 2010

(51) Int. Cl. G09B 5/00

(52) U.S. Cl. 434/307 R

(57) ABSTRACT

Methods and software applications targeted to and for use by infant users. Various activities are presented to infant users through a touch-screen based monitor and, depending on the input entered by infant users, emotionally positive or emotionally negative indications are presented to the infant user. The emotionally positive indications are designed to reinforce desirable results caused by the infant user's input while the emotionally negative indications are designed to discourage undesirable result from the infant user's input. Various environments and activities based on these environments and areas are provided to the infant user by way of the monitor.

### TECHNICAL FIELD

The present invention relates to software for use by young and very young users. More specifically, the present invention relates to a software application for use by infant or near infant users to assist in or accelerate growth of brain development as well as other skills.

### BACKGROUND OF THE INVENTION

Recent developments in touch-screen based handheld and tablet computers have given rise to an increase in their use in everything ranging from business applications to online entertainment. One area which has, as yet, not been penetrated by the increasingly ubiquitous handheld computing devices is that of infant education or infant entertainment.

The popularity of the Baby Einstein(™) line of products has shown that there is great interest in educational and/or entertainment multimedia products. These products, properly designed, may assist in the development of the infant and near-infant user's observational skills. In addition, such properly designed products may also be designed to help in developing and even accelerating the user's musical, mathematical, and/or language skills.

Currently, there are electronic devices which can be adapted for use by or are designed for use by children ages older than 3 or 4. However, there are currently no devices or associated games designed specifically for children under the age of 3 or 4.

Younger users, such as those younger than 3 or 4 years old, are still developing their cognitive abilities and thus need more direct interaction without the need for abstract thought. As such, larger icons, direct visual cues, direct and clear responses from devices in a way which infants can understand, would provide more accessible activities for the younger users.

In terms of direct and clear responses which infants can understand, the reward system usually used in entertainment and/or educational games would be inapplicable to games for use by much younger users. As can be imagined, the typical scoring system normally used to determine winners and losers in most gaming environments, would be inaccessible to users younger than 3 or 4 years old. Because of this, a new, more accessible reward system for such users is needed.

Applications for such young users may also be inaccessible as system/game/application design should take into account the cognitive abilities of their target users. As an example, infant users who are only a few months old do not have the capability to distinguish between multiple color palettes. Because of this, applications for younger users may need to be designed in an age-appropriate manner so that younger users can maximize the benefit afforded by such products.

Following on the above point, no game applications currently exist which take into account the needs of the much younger users and which provide an approach that not only provides entertainment but a phased educational approach as well.

There is therefore a need for game applications that are specifically designed for the education and entertainment of toddlers.

### SUMMARY OF INVENTION

The present invention provides methods and software applications targeted to and for use by infant users. Various activities are presented to infant users through a touch-screen based monitor and, depending on the input entered by infant users, emotionally positive or emotionally negative indications are presented to the infant user. The emotionally positive indications are designed to reinforce desirable results caused by the infant user's input while the emotionally negative indications are designed to discourage undesirable result from the infant user's input. Various environments and activities based on these environments and areas are provided to the infant user by way of the monitor.

In a first aspect, the present invention provides a method for use in providing entertainment and educational content and activities to infants, the method comprising:

a) providing an infant user with visual cues and visual indicia by way of a computing device monitor having a touch screen interface;

b) receiving input from said infant user through said touch screen interface, said input being for interacting with at least one visual cue on said computing device monitor;

c) in the event said input indicates that said infant has entered a desirable result, providing a reward to said infant user through said monitor, said reward being an emotionally positive indication of said infant's performance, said reward being for eliciting a positive reinforcement reaction from said infant;

d) in the event said input indicates that said infant has not entered a desirable result, providing to said infant user an emotionally negative indication of said infant user's performance using said monitor;

wherein said visual cues and visual indicia are for enhancing said infant user's observational skills.

In a second aspect, the present invention provides computer readable media having encoded thereon computer readable instructions implementing a method for use in providing entertainment and educational content and activities to infants, the method comprising:

a) providing an infant user with visual cues and visual indicia by way of a computing device monitor having a touch screen interface;

b) receiving input from said infant user through said touch screen interface, said input being for interacting with at least one visual cue on said computing device monitor;

c) in the event said input indicates that said infant has entered a desirable result, providing a reward to said infant user through said monitor, said reward being an emotionally positive indication of said infant's performance, said reward being for eliciting a positive reinforcement reaction from said infant;

d) in the event said input indicates that said infant has not entered a desirable result, providing to said infant user an emotionally negative indication of said infant user's performance using said monitor;

wherein said visual cues and visual indicia are for enhancing said infant user's observational skills.

### BRIEF DESCRIPTION OF THE DRAWINGS

The embodiments of the present invention will now be described by reference to the following figures, in which identical reference numerals in different figures indicate identical elements and in which:

FIG. 1 is a schematic illustration of an activity provided by software according to one aspect of the invention;

FIG. 2 is a schematic illustration of a zoo or animal based activity provided by software according to another aspect of the invention;

FIG. 3 is a schematic illustration of a music based environment for a music based activity according to another aspect of the invention;

FIG. 4 is a schematic illustration of a kitchen environment for use in an activity according to another aspect of the invention;

FIG. 5 is a schematic illustration of a farm environment for use in activities according to another aspect of the invention;

FIG. 6 illustrates a schematic diagram of a park environment for use in a park based activity according to another aspect of the invention;

FIG. 7 is a schematic illustration of an alphabet based activity according to another aspect of the invention;

FIG. 8 illustrates a possible emotionally positive indication for presenting to an infant user according to one aspect of the invention; and

FIG. 9 illustrates a possible emotionally negative indication for presenting to an infant.

### DETAILED DESCRIPTION OF THE INVENTION

The following description and attached diagrams are provided as examples of possible configurations and functionalities of software which fall under the scope of the present invention. They are not to be taken as in any way limiting the scope of the present invention.

As noted above, there is a need for entertainment and educational software applications for toddlers or infants under the age of 3 or 4. Such infant users will, of course, have special needs that the software applications will need to address. As an example, these infant users may not be completely able to use and/or manipulate regular I/O interfaces such as keyboards and mice. These infant users will, however, be able to use touch screen interfaces and it is these interfaces that will be the preferred interface for such software.

Another possible special need for infant users is their limited visual acuity. As such, such software would need large, easily visible icons and visual cues and indicia so that they may be easily seen and perceived by the infant users.

It should be noted that ease of use of the software for the infant users, such as the large icons and other visual indicia and the touch screen interface, are not the only preferable features of the software. The activities presented by the software should also be very simple, easy to understand, and accessible to the infant users. As such, activities such as color matching, identifying and matching simpler shapes, images, and icons would be ideal for the infant user using the software. Also, simple musical matching, musical instrument identification, and possibly simple musical instrument simulation may be presented to the infant user.

To simplify the activities further so that they are accessible to infant users, a reward system that is readily identifiable and applicable to infant users may be presented as part of the software. As may be imagined, providing scores and achievement bonuses, used in traditional entertainment software reward systems, may not be applicable or accessible to infant users. As such, another reward system that provides emotionally positive indications of the infant user's performance may be used when the infant user's input causes a desirable result (e.g. matching one icon with another). Rewards such as a smiling avatar (a smiling or happy face), happy music, upbeat music or music fragments, sounds of celebration, a laughing sound, a happy animation (e.g. a dog playing, a child happily playing, bright colors flashing, etc.), the sound of clapping, providing access to other activities/areas of the software application, and other emotionally positive indications would be more accessible to the infant user. Similarly, when the infant user enters an undesirable input (i.e. the infant user's input is “incorrect” or is not what is desired by the application) emotionally negative indications of the infant user's performance may be used. These emotionally negative indications may take the form of a frowning avatar, a sad face, jarring sounds such as a dog barking angrily, a downbeat tune, a loud noise, a large flashing “X” and other clearly negative indications.

It should be noted that emotionally positive indications may be a combined audio and visual presentation to the infant user. As an example, the infant user may be presented with the smiling face of an avatar along with the sounds of laughter and/or happy music. Such images and/or sounds are, preferably, designed to reinforce the infant user's behaviour and perceptions being promoted by the activities. If the images and sounds presented to the infant user as emotionally positive indications are designed to elicit a positive response from the infant user (e.g. making the infant user happier, more upbeat) then it is more likely that the desirable behaviour exhibited by the infant user will be reinforced. Similarly, emotionally negative indications are, preferably designed to discourage behaviour that is not considered desirable (e.g. matching wrong colors). These emotionally negative indications may also be combined for a similar audiovisual presentation. As an example, a sad avatar or a sad face may be shown to the infant user while simultaneously playing a crying baby sound.

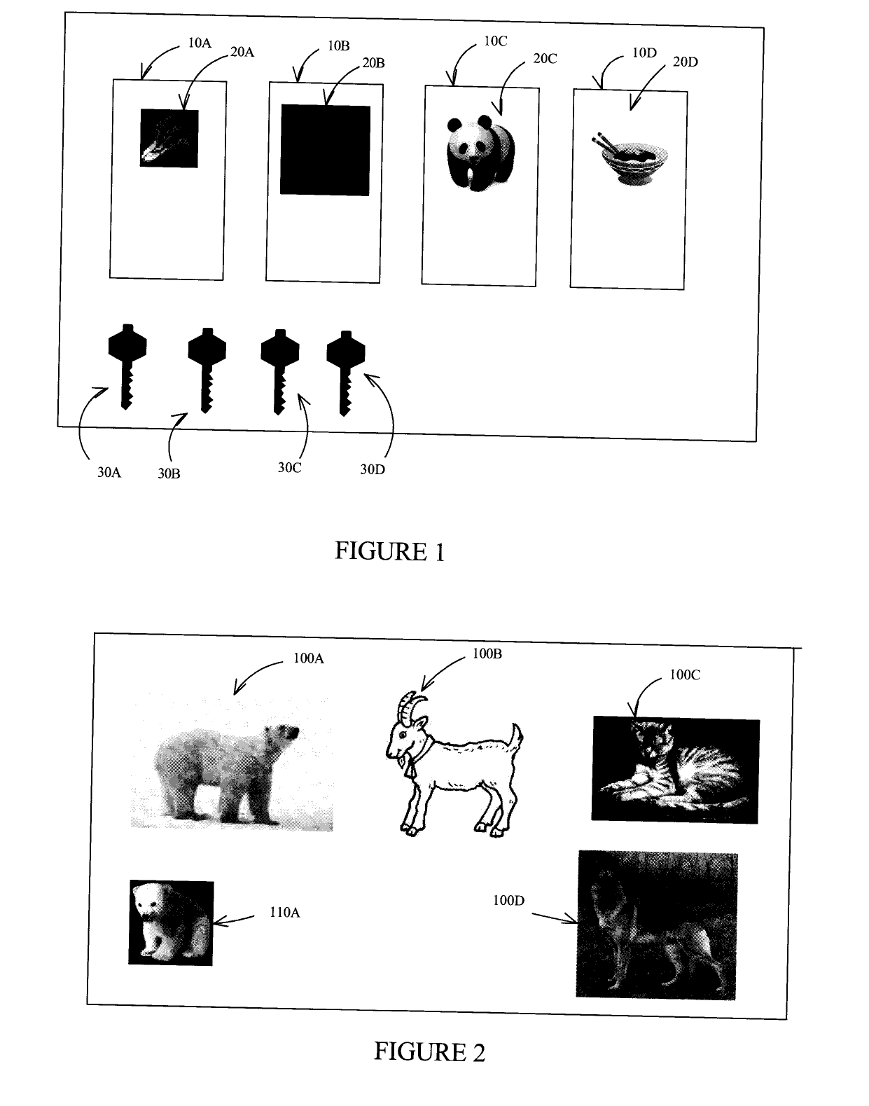

Referring to FIGS. 1-9, sample schematic screens explaining the above concepts are provided. As will be explained below, the activities provided should serve to entertain and, preferably, educate and develop the infant user's abilities. The following activities explained below are designed to promote and/or enhance the infant user's observational skills. The infant user will observe the visual indicia on the monitor and, by seeing similarities between specific visual indicia and, with possibly some prompting from an older user, manipulate the on-screen visual indicia appropriately.

Referring to FIG. 1, a schematic of a screen shot of one environment illustrating the invention is shown. As can be seen, the infant user is provided with a number of doors 10A, 10B, 10C, 10D of varying colors and, preferably, with varying icons 20A, 20B, 20C, 20D with each icon representing the activities accessible by activating the specific door. A number of keys 30A 30B 30C 30D are also provided at the bottom of the screen. Each key has a different color and each key color corresponds to a color of one of the doors 10A-10D. The infant user can press and drag each of the keys 30A-30D to one of the doors 10A-10D. If the infant user drags a key to the door with the same color as the key, this constitutes a desirable input. If this occurs, then an emotionally positive indication or event is presented. As noted above, the emotionally positive indication may be a happy sound, a smiling face, or any one of a number of events which would elicit an emotionally positive response from the infant user. As well, the infant user would be granted access to the activities represented by the icon on the door to which the correct key was matched. A vegetable icon 20A would represent a farm area and farming related activities would be accessible. A trumpet icon 20B would represent a music area and music related activities would be accessible. An animal icon 20C would represent a zoo area and zoo or animal related activities would be accessible. A dishes icon 20D would represent a kitchen area and kitchen or food related activities would be accessible. Of course, if the infant user were to drag a key to a door whose color does not match that of the key, then an emotionally negative indication, as explained above, would be presented to the infant user. The user would then be allowed to enter another input by dragging another key to another door.

It should be noted that the environment in FIG. 1 may have a background illustrating a baby's playpen or a baby's room. Thus, the background to the doors may illustrate a bed, tables, suitable wallpaper on the walls, etc.

Referring to FIG. 2, a schematic of a screen shot of a zoo environment illustrating the invention is shown. The zoo environment may be accessed by the infant user if the key corresponding to the door with the animal icon were dragged to that specific door using the touch screen interface.

In one example of a zoo or animal based activity, FIG. 2 illustrates that a number of adult animals 100A 100B 100C 100D are presented to the infant user along with a single infant animal 110A at the corner of the screen. The infant user has to drag the infant animal 110A to the correct adult (or mother) animal 100A. If the infant user incorrectly drags infant animal 110A to one of the non-matching adult animal 100B 100C 100D, then an emotionally negative indication is presented to the infant user and the incorrectly matched adult animal may be removed from the screen. If the infant user enters a desirable input, in this case dragging the infant animal 110A to the correct corresponding adult animal 100A, then an emotionally positive indication is presented to the infant user.

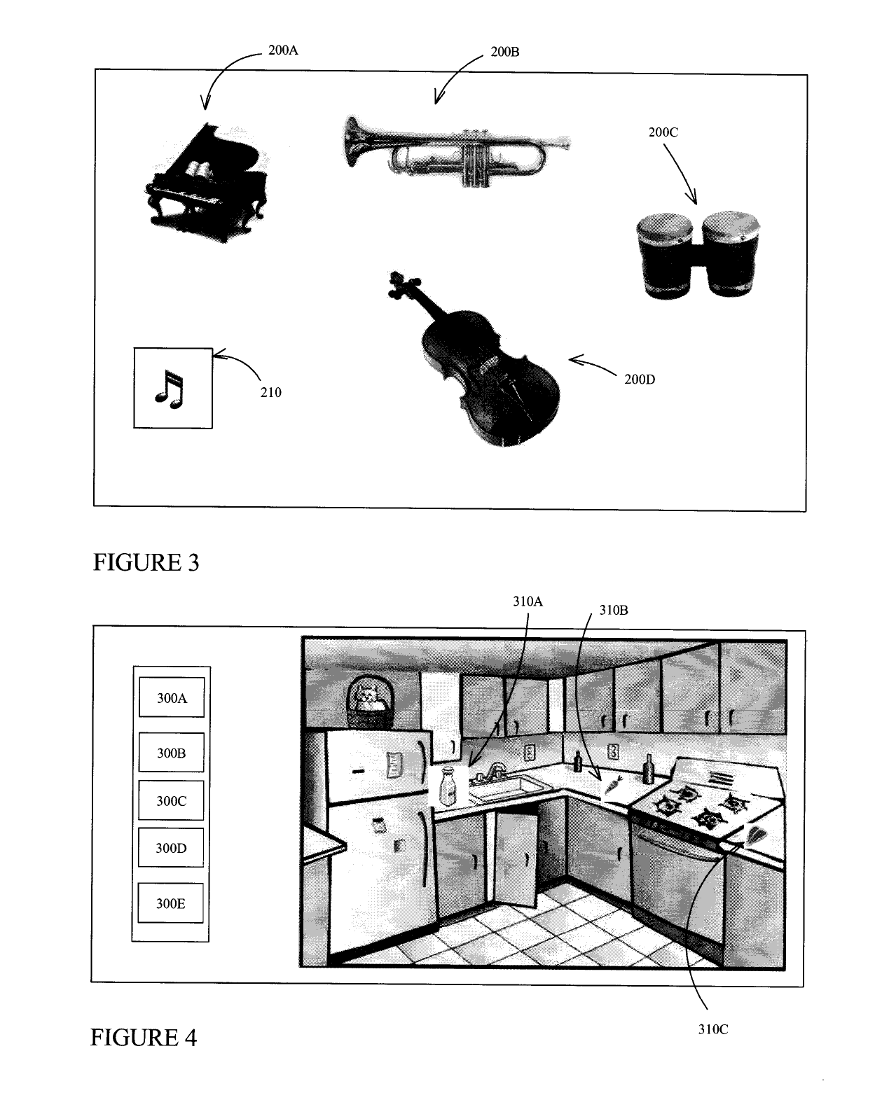

Referring to FIG. 3, a schematic of a screen shot of a music environment illustrating the invention is shown. In one implementation, the music environment may be accessed by the infant user if the key corresponding to the door with the trumpet icon were dragged to that specific door using the touch screen interface.

As can be seen from FIG. 3, icons 200A, 200B, 200C, 200D illustrate different musical instruments. An activate icon 210 is presented at a bottom corner of the screen. Once the infant user activates the activate icon 210, a short tune, which consists of a single instrument being played, is played. The infant user then has to either touch the correct musical instrument icon that corresponds to the instrument played. As an example, if the tune is that of a trumpet being played, if the infant user activates the trumpet icon 200B then an emotionally positive indication is presented to the infant user. As another example of a musical activity, activating a piano icon would present the infant user with a single octave keyboard. The infant user can play on the keys and hear the sound of the piano. If the infant user activates a game activity on the piano, a short musical fragment is played. If the infant user plays back the musical fragment (i.e. plays the notes in the correct sequence using the single octave keyboard on the screen), an emotionally positive indication is presented to the infant user. Of course, if the correct sequence of notes is not played back, then an emotionally negative indication is presented to the infant user.

Referring to FIG. 4, a schematic of a screen shot of a kitchen environment or kitchen area illustrating the invention is shown. In one implementation, the kitchen environment may be accessed by the infant user if the key corresponding to the door with the dishes icon were dragged to that specific door using the touch screen interface. In one implementation, the kitchen environment is represented as being a typical kitchen with cupboards, appliances, and a sink area.

In one activity available in the kitchen area, a number of slots 300A-300E are presented at the bottom of the screen. Various food items 310A-310C are scattered throughout the kitchen environment. The infant user can drag any of the food items 310A-310C to the slots 300A-300E and, when a nutritionally balanced combination is in the slots, then an emotionally positive indication is presented to the infant user. If all the slots are filled and a nutritionally balanced combination is not found within the food items in the slots, then an emotionally negative indication is presented and the slots are emptied with the food items being re-scattered throughout the kitchen environment.

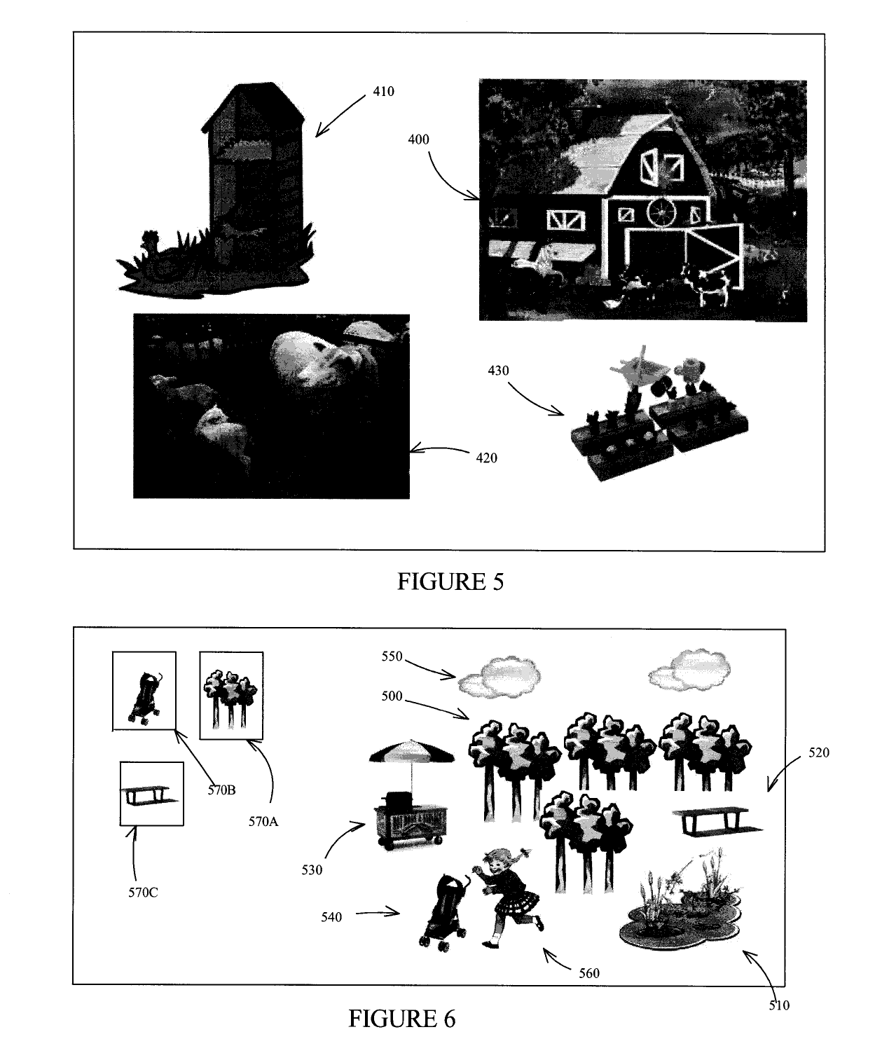

Referring to FIG. 5, a schematic of a screen shot of a farm area or farm environment illustrating the invention is shown. In one implementation, the farm environment may be accessed by the infant user if the key corresponding to the door with the vegetable patch icon were dragged to that specific door using the touch screen interface. In one implementation, the farm is represented as having a barn area 400, a chicken coop 410 with multiple chickens in nests, a lamb holding pen 420, and a vegetable garden area 430.

When the infant user activates any of the areas of the farm environment, a different activity is activated and a new screen may be presented for that activity.

When the barn area is activated, a cow may be illustrated and the infant user can, using the touch screen, simulate milking the cow by simply touching the cow. A suitably emotionally positive animation is then played along with suitably emotionally positive sounds and music. The resulting milk may then be shown as being bottled and/or placed in a truck.

When the lamb holding pen is activated, a lamb is presented to the infant user. By touching the lamb, the infant user activates a simulation of the lamb being sheared of its wool. An animation of the lamb being sheared can then be presented to the infant user. Again, suitably emotionally positive indications (e.g. happy music, happy sounds, the sound of a lamb braying, etc., etc.) may be presented to the infant user simultaneous to the animation being played.

For the vegetable garden area, when the infant user activates this area, a vegetable garden is presented to the infant user. The infant user can then pick the vegetables in the garden and place them in a basket in a corner of the screen. The vegetables are originally shown as sprouting from the ground with only their tops showing. When the infant user activates each vegetable top by touching its location on the screen, a full representation of the appropriate vegetable is presented and this can be dragged to the basket at the side of the screen. For each vegetable “picked” from the garden, a suitably emotionally positive indication can be presented to the infant user. For this activity, the emotionally positive indication may be a cheering sound, a clapping sound, or any other suitably happy sound and/or animation may be used. Once the basket is full, another animation—this time that of filling a stall in a market with the vegetables in the basket—may be presented to the infant user.

For the chicken coop area, activating the icon presents the infant user with a number of chickens on their nests. The infant user can activate each chicken by touching the screen where the chicken is located. This activates an animation which would show whether there is an egg underneath the chicken. Each egg discovered would cause a suitably emotionally positive indication to the infant user. Each egg can then be shown as being placed in an egg container.

Another possible environment similar to the above environments would be that of a park environment or park area. FIG. 6 illustrates such an area where the infant user can access other activities. While not pictures in FIG. 1, a suitable door with a suitable icon and corresponding key may be used to access the park area as explained above for the various other areas and environments.

As can be seen in FIG. 6, the park environment would have a multitude of icons representing objects normally seen in or from a park. Trees 500, a pond 510, bench 520, hotdog cart 530, stroller 540, clouds 550, and people 560 are illustrated. One possible activity for this environment would involve flash cards 570A-570C which illustrate things found on the screen for the environment. The items or things illustrated on the flash cards 570A-570C would then need to be matched to the matching card. As an example, the infant user can drag flash card 570A illustrating a tree to the tree 500. When this occurs, a suitably emotionally positive indication can be presented to the infant user. If, on the other hand, the infant user incorrectly matches a card with an object (e.g. flash card 570B illustrating a person is dragged to the stroller 540), then a suitably emotionally negative indication is presented to the infant user. In one variant of the activity, the emotionally positive indication may be presented to the infant user after he/she matches a number of flash cards. After a match is made, the matching card may be replaced by another, random card.

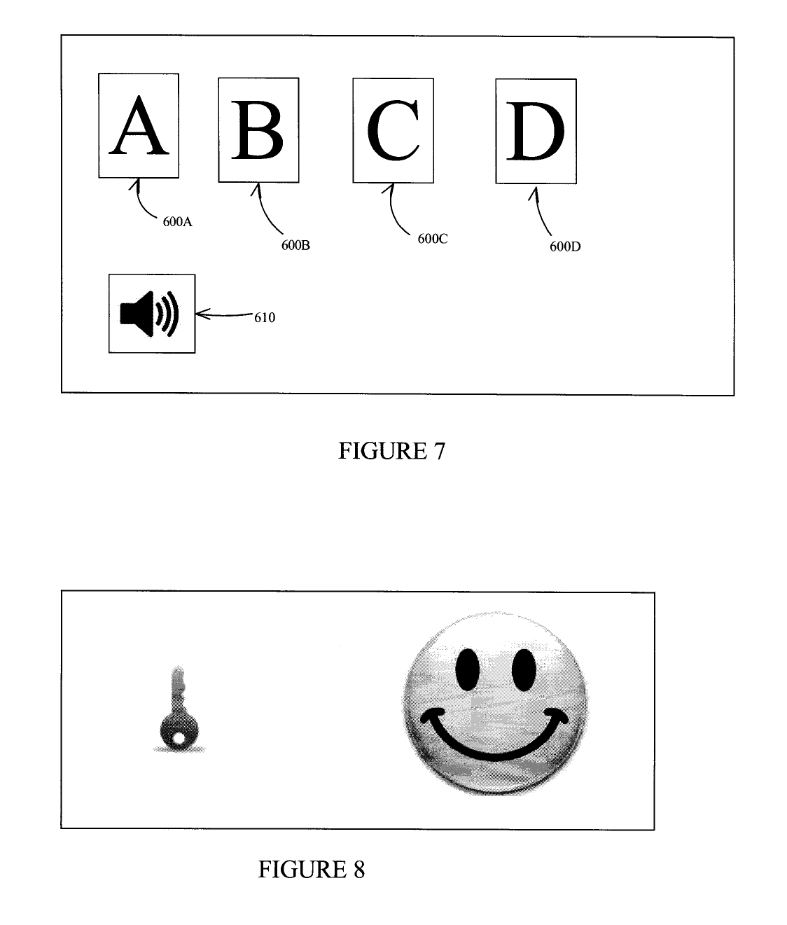

Referring to FIG. 7, another activity which the infant user may activate involves the recognition of letters and their sounds. As shown in FIG. 7, a number of icons 600A-600E are presented to the infant user with an activate or Play button 610 at the corner of the screen. Once the activate button has been pressed (using the touch screen interface), a recording of a letter being spoken is played. The infant user then has to press the appropriate letter on the screen. A correct answer will reward the infant user with an emotionally positive indication. An incorrect answer will present the infant user with an emotionally negative indication. Of course, the letters in FIG. 7 and the activity as a whole may involve, instead of letters, numbers or other educational indicia.

Regarding the emotionally positive indication, FIG. 8 illustrates a possible emotionally positive indication which may be presented to the infant user. As can be seen in FIG. 8, a happy, smiling face is presented and, if the activity used is that illustrated in FIG. 1, the correct key used is also presented. A suitable happy tune and/or sound recording may be played in conjunction with the presentation of the smiling face. It should be noted that the smiling face may be animated as opposed to a static image.

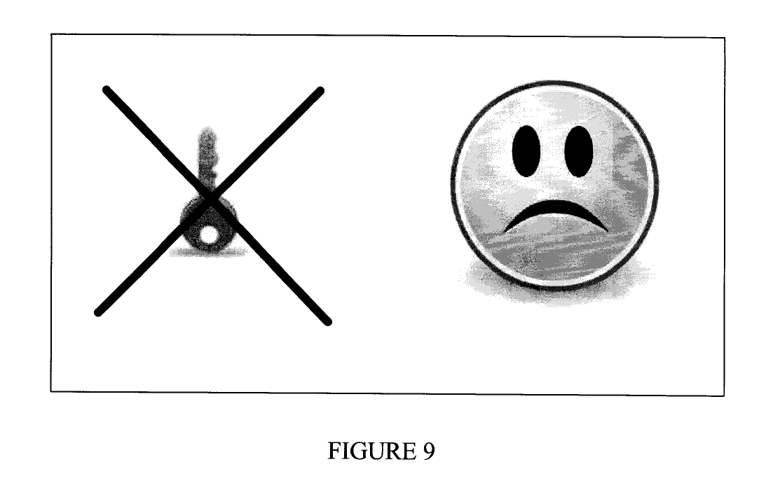

Regarding the emotionally negative indication, FIG. 9 illustrates a possible emotionally negative indication which may be presented to the infant user. As can be seen, a frowning face is presented to the infant user to indicate that an incorrect or an undesirable input has been detected. As with FIG. 8, if the activity being used is that illustrated in FIG. 1, the wrong key selected is shown but this time with a large X indicating that it is the wrong key. Also with the frowning face (or a frowning avatar), suitably emotionally negative sounds (such as a jarring sound or a discordant buzzer sound) may be played while displaying the images. The images may be animated.

As another example of an emotionally positive indication of the infant user's performance, a gold star may be awarded to the infant user every time he or she enters a desirable input to the software. The gold star, or other suitable award, may then be provided to the infant user as a virtual sticker which may then be shown to the infant user whenever it is called up.

It should be noted that prompts and hints or instructions may be provided to parents or other adults who may be assisting the infant user. A balloon may appear at certain stages of an activity to prompt the adult helper to explain a concept, activity, or to instruct the adult as to what to do to maximize the benefit of the experience or activity for the infant user. These instructions, hints, or prompts are, preferably, non-intrusive to the infant user's experience regarding the activity.

Because the infant user may range in age from a few months old to up to 4 years old, a phased approach to education/entertainment may be used in conjunction with the various activities described above. As an example, less onerous activities or activities which require more developed cognitive abilities or more developed observational skills may be provided later in an application with the simpler activities being provided to the younger of the users. The activities which require color matching may be reserved for older infant users as the very young infant users may not be able to distinguish between the various colors. As well, activities which would require better spatial sense or a more developed ability to distinguish different sounds or images would be reserved for the older infant users.

In one implementation, a software application having the various activities described above would have a phased approach in that the activities are nested so younger infant users can only access the simplest of activities. As the infant user grows older and develops more cognitive abilities (and can, hence, participate in and complete more of the activities) more complicated and complex activities become available to that user. As an example, activities involving music fragments and/or identifying musical instruments may be inaccessible to six month old infant users but may be fully accessible to 3 or 4 year old infant users.

The phased approach noted above preferably does not just apply to the activities provided to the infant user. The color palette used in presenting the activities, the rewards, and indeed the whole look and feel of the user interface preferably also takes into account the cognitive abilities of the infant user. The software application can be told (by an adult user assisting the infant user) the age (in months and/or years) of the infant user and the application can adjust its color palette so that the various icons and indicia are actually distinguishable by the infant user. As an example, for infant users who are less than a year old, pastel colors may be removed from the color palette used by the application as such young infant users are unable to distinguish between the different pastel colors. Of course, for infant users older than one or two years old, the pastel colors are placed back in the color palette automatically.

The emotionally based reward system noted above may also use a phased approach. Sounds or images that might be considered too jarring or too unpleasant for very young infant users are not used if an age input to the software application indicates that such sounds or images are inappropriate. As an example, the sound of a dog barking as an emotionally negative indication might be inappropriate for a six month old infant user but it might be appropriate for a 3 year old infant user. Similarly, bright flashing lights or bright flashing icons as an emotionally positive indication may be appropriate for and can therefore be presented to 2-3 year old infant users. Such emotionally positive indications may, however, be inappropriate for 7 month old infant users. For such users, more age appropriate emotionally positive indications may be used.

As can be imagined from the above, the phased approach to the application would entail different colors, activities, and rewards for different age groups. As the infant user changes by growing older, these colors, activities, and rewards change with the infant user. The various age levels of the infant user may be delimited on a month to month basis (e.g. a 4 month old infant user will have different settings from a 5 month old infant user) or a year by year basis (e.g. a 1 year old infant user will have different settings from a 2 year old infant user). It should be noted that the age of the infant user may be entered by the adult user assisting the infant user.

For the younger infant users, the activities may be very simple experiential activities which would encourage the infant user to “experience” or “explore” different everyday objects. As an example, by touching an apple icon, the infant user would be provided with the sound of someone biting into an apple. In another example, activating a specific instrument's icon would cause a playback of that instrument. Other, simple exploration or experiential activities may also be used.

With the infant user growing older and developing further cognitive capabilities, other, more complex activities may be introduced by the application. As an example, color matching activities (e.g. the key to door matching activity associated with FIG. 1) and other matching activities (e.g. the animal cub matching with mother animal activity associated with FIG. 2) may then be provided to the infant user.

The touch screen interface also provides a more active method of interacting with the infant user and, as such, promotes curiosity and a more active approach. As an example, to teach differences between shapes, the infant user may be provided with a bicycle object with which the infant user can interact. To show the differences between a square and a circle, the bicycle may be provided with square tires and the infant user can drag the bicycle across the screen without the square tires rotating. Another bicycle object, this time with circular tires, may then be provided to the infant user. Dragging this object across the screen is shown as being easier and the circular tires are shown as rotating.

The activities described above and a software application that includes at least a few of these activities would serve to promote a more active, curious, and hopefully healthier lifestyle for the infant user as he or she grows older. The activities mimic healthy lifestyle choices—such as interacting in a park environment or a farm environment—and also promote a healthier diet by inculcating healthy eating habits.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language For example, preferred embodiments may be implemented in a procedural programming language (e.g.“C”) or an object oriented language (e.g.“C++”, “java”, or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

Having thus described the invention, what is claimed as new and secured by Letters Patent is:

1. A method for use in providing entertainment and educational content and activities to infants, the method comprising:
a) providing an infant user with visual cues and visual indicia by way of a computing device monitor having a touch screen interface;
b) receiving input from said infant user through said touch screen interface, said input being for interacting with at least one visual cue on said computing device monitor;
c) in the event said input indicates that said infant has entered a desirable result, providing a reward to said infant user through said monitor, said reward being an emotionally positive indication of said infant's performance, said reward being for eliciting a positive reinforcement reaction from said infant;
d) in the event said input indicates that said infant has not entered a desirable result, providing to said infant user an emotionally negative indication of said infant user's performance using said monitor;
wherein said visual cues and visual indicia are for enhancing said infant user's observational skills.

2. A method according to claim 1 wherein said reward comprises presenting a smiling face to said infant user.

3. A method according to claim 1 wherein said reward comprises playing specific happy sounds for said infant user.

4. A method according to claim 1 wherein said emotionally negative indication comprises playing at least one unpleasant sound for said infant user.

5. A method according to claim 1 wherein said emotionally negative indication comprises presenting a frowning face to said infant user.

6. A method according to claim 1 wherein said reward comprises allowing access for said infant to other activities.

7. A method according to claim 1 wherein said desirable result comprises causing a specific desirable event through said touch screen interface.

8. A method according to claim 3 wherein said happy sounds comprises at least one of laughter sounds, happy music tunes, clapping sounds, and cheering sounds.

9. A method according to claim 3 wherein said reward comprises presenting an animation sequence to said infant.

10. A method according to claim 4 wherein said at least one unpleasant sound comprises at least one of a loud discordant sound, a barking sound, a crying sound, and a loud unpleasant tune.

11. A method according 7 wherein desirable event comprises matching a first symbol pictured on said monitor with a suitable second symbol also pictured on said monitor by dragging said first symbol to said second symbol through said touch screen interface.

12. A method according to claim 6 wherein said other activities relate to different environments, said environments comprising at least one of:
a park environment
a music environment
a kitchen environment
a zoo environment
a farm environment

13. A method according to claim 1 further including providing visual clues and instructions for an older user, said visual clues and instructions being for assisting said older user in helping said infant user with said activities.

14. Computer readable media having encoded thereon computer readable instructions implementing a method for use in providing entertainment and educational content and activities to infants, said method comprising:
a) providing an infant user with visual cues and visual indicia by way of a computing device monitor having a touch screen interface;
b) receiving input from said infant user through said touch screen interface, said input being for interacting with at least one visual cue on said computing device monitor;
c) in the event said input indicates that said infant has entered a desirable result, providing a reward to said infant user through said monitor, said reward being an emotionally positive indication of said infant's performance, said reward being for eliciting a positive reinforcement reaction from said infant;
d) in the event said input indicates that said infant has not entered a desirable result, providing to said infant user an emotionally negative indication of said infant user's performance using said monitor;
wherein said visual cues and visual indicia are for enhancing said infant user's observational skills.
